(19) United States
(12) Patent Application Publication
(10) Pub. No.: US 2015/0258784 A1
(43) Pub. Date: Sep. 17, 2015

(54) LIQUID DROPLET EJECTION HEAD AND IMAGE FORMING APPARATUS

(71) Applicant: FUJI XEROX CO., LTD., Tokyo (JP)

(72) Inventors: Kumiko TANAKA, Kanagawa (JP); Atsumichi IMAZEKI, Kanagawa (JP)

(21) Appl. No.: 14/627,332

(22) Filed: Feb. 20, 2015

(30) Foreign Application Priority Data
Mar. 14, 2014 (JP) 2014-052456

(51) Int. Cl. B41J 2/14

(52) U.S. Cl. CPC B41J 2/1433; B41J 2002/14411

(57) ABSTRACT

Provided is a liquid droplet ejection head provided with an ejection hole that is opened on an ejection surface and ejects a liquid droplet, and a groove that extends with one end separated from the ejection hole to the other end further separated from the ejection hole than the one end on the ejection surface.

### CROSS-REFERENCE TO RELATED APPLICATIONS

This application is based on and claims priority under 35 USC 119 from Japanese Patent Application No. 2014-052456 filed Mar. 14, 2014.

### BACKGROUND

### Technical Field

The present invention relates to a liquid droplet ejection head and an image forming apparatus.

### SUMMARY

According to an aspect of the invention, there is provided a liquid droplet ejection head provided with:

an ejection hole that is opened on an ejection surface and ejects a liquid droplet; and

a groove that extends with one end separated from the ejection hole to the other end further separated from the ejection hole than the one end on the ejection surface.

### BRIEF DESCRIPTION OF THE DRAWINGS

Exemplary embodiments of the present invention will be described in detail based on the following figures, wherein:

FIG. 1 is an underside view illustrating apart of a nozzle surface of a liquid droplet ejection head according to an exemplary embodiment of the invention when viewed from below;

FIG. 2 is a perspective view illustrating a part of the nozzle surface of the liquid droplet ejection head according to the exemplary embodiment of the invention;

FIG. 3 is an underside view illustrating an entire nozzle surface of the liquid droplet ejection head according to the exemplary embodiment of the invention when viewed from below;

FIG. 4 is a cross-sectional view illustrating the liquid droplet ejection head according to the exemplary embodiment of the invention; and

FIG. 5 is a view schematically illustrating a configuration of an image forming apparatus according to the exemplary embodiment of the invention.

### DETAILED DESCRIPTION

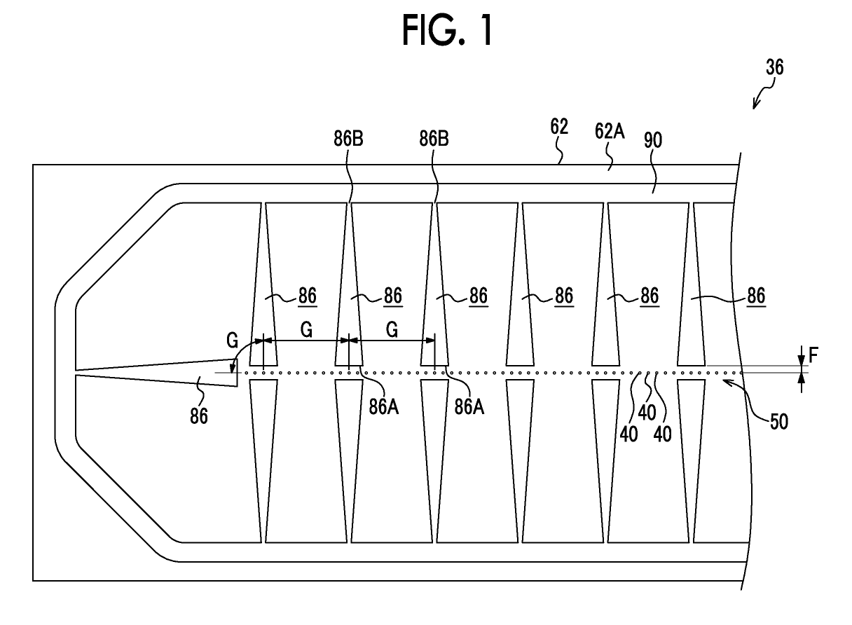

Examples of a liquid droplet ejection head according to an exemplary embodiment of the invention and an image forming apparatus that includes the liquid droplet ejection head are described with reference to FIGS. 1 to 5. Arrow UP illustrated in the drawings indicates an upward direction in the vertical direction.

Entire Configuration

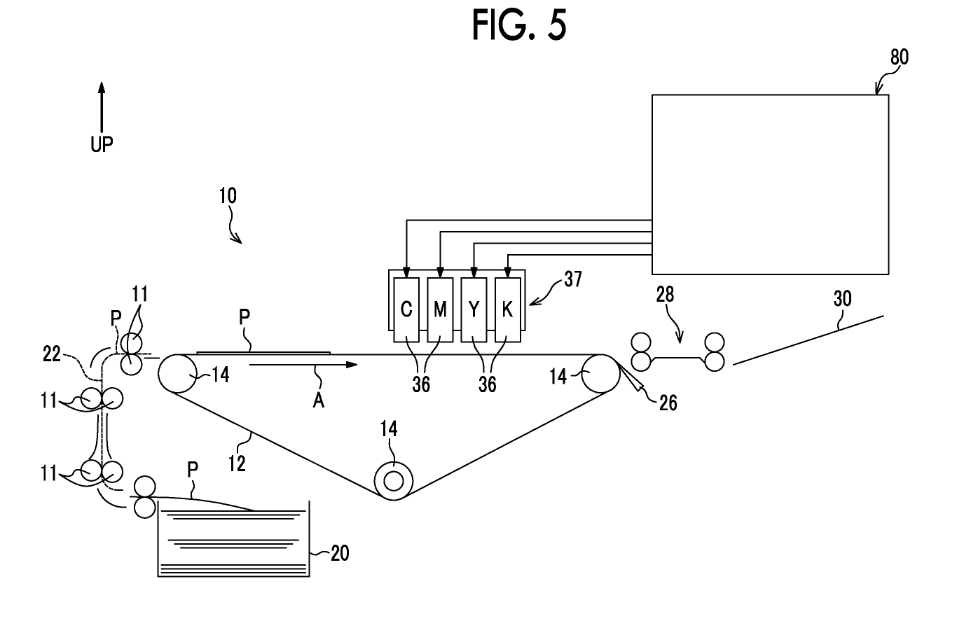

In FIG. 5, a schematic configuration of an image forming apparatus 10 according to the exemplary embodiment is described. The image forming apparatus 10 is a so-called full width array (FWA) type inkjet printer.

As illustrated in FIG. 5, the image forming apparatus 10 includes an endless transporting belt 12 (example of a transporting member) which loops over plural rollers 14. A rotary power from a drive unit (not illustrated) is transmitted to one roller 14 out of the plural rollers 14 and the transporting belt 12 is caused to circle around in a direction of arrow A (hereinafter, “belt circling direction”) in FIG. 5. The transporting belt 12 has a function of contact-holding of a sheet member P as a recording medium.

In addition, the image forming apparatus 10 includes a sheet storage unit 20 in which the sheet members P are stacked and stored and plural transporting rolls 11 which transport the sheet member P stored in the sheet storage unit 20 along a transporting path 22.

In this configuration, the sheet member P stored in the sheet storage unit 20 is picked up one by one from the uppermost position by a pick-up mechanism (not illustrated), and transported by the transporting rolls 11 along the transporting path 22 so as to be delivered onto the transporting belt 12. The sheet member P delivered onto the transporting belt 12 is contact-held by the transporting belt 12 so as to be transported in the belt circling direction.

Further, a head array 37 is disposed to face the sheet member P that is transported by the transporting belt 12 along the transporting path of the sheet member P. The head array 37 includes four liquid droplet ejection heads 36 that eject an ink droplet (example of a liquid droplet) onto the sheet member P.

The four liquid droplet ejection heads 36 have the same configuration and are provided for cyan (C) ink ejection, magenta (M) ink ejection, yellow (Y) ink ejection, and black (K) ink ejection from the upstream side in the belt circling direction. The sheet member P that is transported by the transporting belt 12 is caused to face the liquid droplet ejection heads 36 for respective colors sequentially and respective color ink droplets are ejected from the liquid droplet ejection head 36 for respective colors onto the sheet member P that is transported such that an image is formed on the sheet member P. The liquid droplet ejection head 36 will be described later.

Further, the image forming apparatus 10 includes a controller 80 that controls the liquid droplet ejection heads 36 for respective colors.

In addition, a scraper 26 that separates the sheet member P from the transporting belt 12 is disposed on the downstream side in the belt circling direction from a portion on the transporting belt 12, which faces the liquid droplet ejection heads 36, to face the roller 14 nipping the transporting belt 12 therebetween.

Further, the image forming apparatus 10 includes an output section 30 to which the sheet member P on which an image is formed is output and an output path 28 that guides the sheet member P which is separated from the transporting belt 12 to the output section 30.

Liquid Droplet Ejection Head

Next, the liquid droplet ejection head 36 will be described.

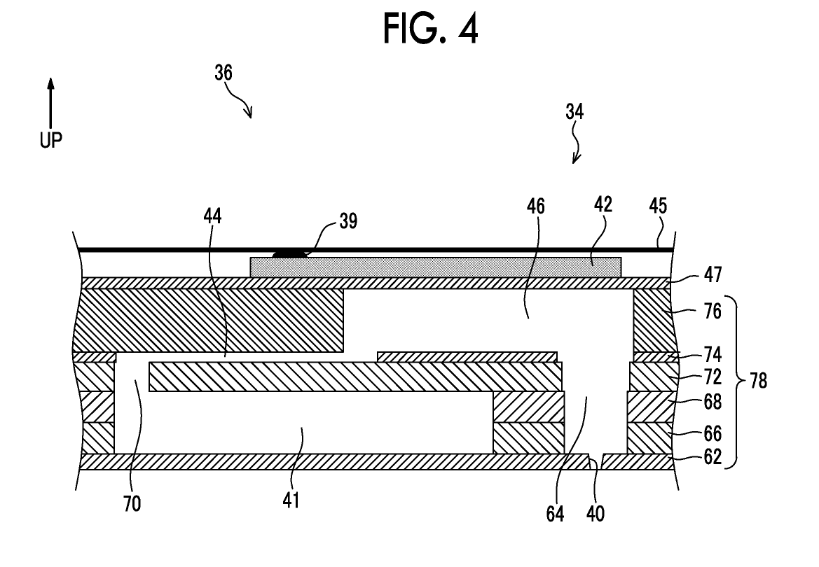

The liquid droplet ejection head 36 is wider than the maximum width of the sheet member P, has a long-length extending in a backward direction of the paper surface in FIG. 5, and includes plural ejectors 34 (refer to FIG. 4) aligned in the longitudinal direction of the liquid droplet ejection head 36. Further, the liquid droplet ejection head 36 includes a common flow path 41 through which ink supplied to each ejector 34 flows.

As illustrated in FIG. 4, the ejector 34 includes a nozzle 40 as an example of an ejection hole that ejects an ink droplet (example of a liquid droplet) and a pressure chamber 46 which is disposed above the nozzle 40 and to which the ink flowing through the common flow path 41 is supplied and which is connected to the nozzle 40.

A nozzle flow path 64 that extends in the vertical direction in FIG. 4 is formed between the pressure chamber 46 and the nozzle 40, and the pressure chamber 46 and the nozzle 40 are connected to each other through the nozzle flow path 64. In addition, between the pressure chamber 46 and the common flow path 41, a flow path 70 that extends upward in FIG. 4 from the common flow path 41 and an ink supplying path 44 that extends rightward in FIG. 4 from an upper end portion of the flow path 70 and reaches a lower end portion of the pressure chamber 46 are formed. The pressure chamber 46 and the common flow path 41 are connected through the flow path 70 and the ink supplying path 44.

These components are formed in a flow path unit 78 in which plates are stacked. This flow path unit 78 includes a nozzle plate 62, an ink pool plate 66, an ink pool plate 68, a through plate 72, an ink supplying path plate 74, and a pressure chamber plate 76, which are stacked from the lower side in this order.

The nozzle 40 described above is formed on the nozzle plate 62. Further, the nozzle flow path 64 and the common flow path 41 are formed on the ink pool plate 66 and the ink pool plate 68, and the flow path 70 and the nozzle flow path 64 are formed on the through plate 72. In addition, the ink supplying path 44 and the nozzle flow path 64 are formed on the ink supplying path plate 74, and the pressure chamber 46 is formed on the pressure chamber plate 76.

Further, the ceiling of the pressure chamber 46 is configured of a vibrating plate 47 stacked on the pressure chamber plate 76, and a drive element 42 is attached on the top surface of the vibrating plate 47 so as to correspond to the pressure chamber 46. In addition, a substrate 45 is disposed above the drive element 42 to be spaced from the drive element 42. The substrate 45 and the drive element 42 are joined by a solder bump 39.

In this configuration, the drive element 42 to which a drive waveform is applied through the substrate 45 by the controller 80 (refer to FIG. 5) changes pressure force with respect to the vibrating plate 47, and a volume of the pressure chamber 46 contracts or expands. Ink accumulated in the pressure chamber 46 due to the volume change of the pressure chamber 46 flows through the nozzle flow path 64 and is ejected as an ink droplet from the nozzle 40 onto the sheet member P.

Configuration of Principal Component

Next, the nozzle plate 62 will be described.

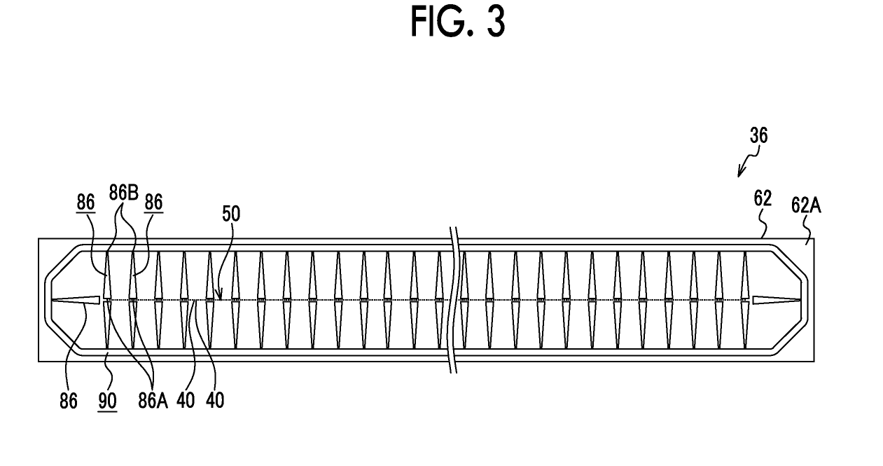

The nozzle plate 62 is formed of a silicon substrate as an example. As illustrated in FIG. 3, the plural nozzles 40 described above are formed on a nozzle surface 62A (example of ejection surface) of the nozzle plate 62 which faces the sheet member P to be aligned in the longitudinal direction of the liquid droplet ejection head 36 (hereinafter, “head longitudinal direction”). The nozzle 40 has a circular shape and the diameter of the nozzle 40 is 25 [μm] as an example. Further, an interval between the adjacent nozzles 40 is 85 [μm] as an example. The plural nozzles 40 that are aligned in the head longitudinal direction form a nozzle row 50.

Further, on the nozzle surface 62A, plural concave grooves 86 of which one end 86A is disposed to be spaced from the nozzle 40 and the other end 86B that is separated away from the nozzle 40 are formed. The edge of the groove 86 is formed to have a U-shaped cross section, for example, by a known etching method or the like and the depth of the groove is 300 [μm] as an example. The hydrophilicity of wall surfaces and bottom which surround the groove 86 is higher compared to the hydrophilicity of the nozzle surface 62A. As an example, when the nozzle surface 62A is uneven (spoiled), the hydrophilicy described above is changed to have a different value.

In addition, as illustrated in FIGS. 1 and 3, the one end 86A of the groove 86 is disposed to be separated from the nozzle row 50 (nozzle 40) by 50 [μm] (distance F in FIG. 1) and the other end 86B of the groove 86 is disposed to be separated from the nozzle row 50 (nozzle 40) compared to the one end 86A. The groove 86 extends in a straight line and the interval of the adjacent grooves 86 (distance G in FIG. 1) is 1 [mm] to 2 [mm] as an example.

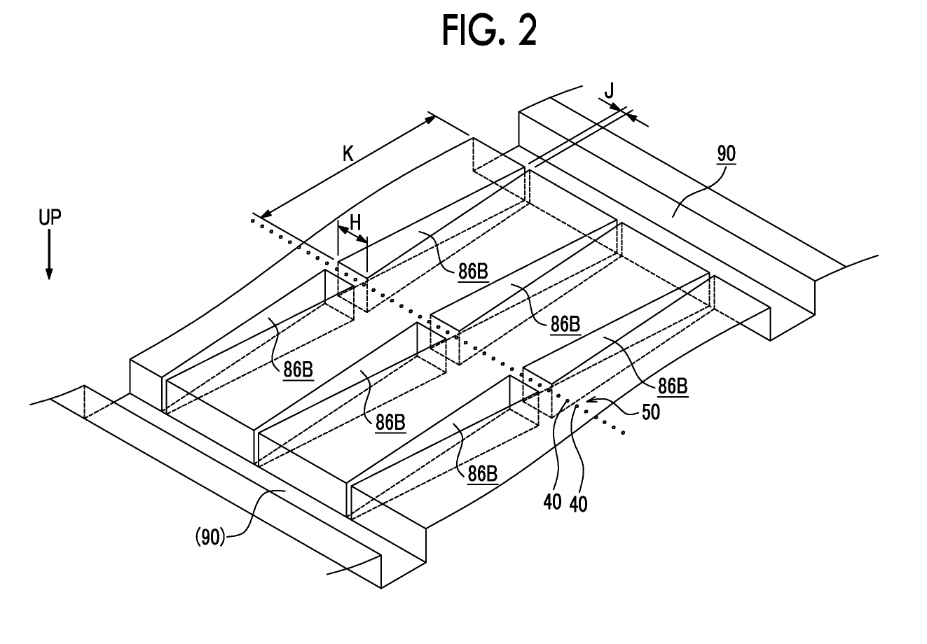

Further, as illustrated in FIGS. 1 and 2, the farther the groove 86 is separated from the nozzle row 50 (nozzle 40), the narrower the width of the groove 86. The width of the one end 86A (distance H in FIG. 2) of the groove 86 is 300 [μm], as an example, and the width of the other end 86B (distance J in FIG. 2) of the groove 86 is 100 [μm], as an example. The length of the groove 86 (distance K in FIG. 2) is 5 [mm] as an example. The width of the groove is preferably 100 [μm] to 500 [μm] so as to produce a capillary phenomenon which will be described later.

In this configuration, mist or the like produced due to the ink droplet ejected from the nozzle 40 is attached around the nozzle 40. Ink (example of a liquid) attached around the nozzle 40 infiltrates into the groove 86 and moves to the other end 86B of the groove 86 where the width thereof becomes narrower.

Further, as illustrated in FIGS. 1 and 3, an annular groove 90 (example of a holding unit) is formed on the nozzle surface 62A to surround the entire groove 86. The edge of the groove 90 is formed to have a U-shaped cross section, for example, by a known etching method or the like and the depth of the groove is 300 [μm] as an example. In addition, the width of the groove 90 is 500 [μm] as an example. The groove 90 is connected to the other end 86B of the groove 86 (flow paths are connected to each other to be continuous) and ink that infiltrates into the groove 86 and moves to the other end 86B of the groove 86 infiltrates into the groove 90 and is held in the groove 90.

Effect of Principal Component

As described above, the one end 86A of the groove 86 is disposed to be separated from the nozzle 40 and the other end 86B of the groove 86 is disposed to be separated away from the nozzle 40 compared to the one end 86A. Ink (liquid) attached around the nozzle 40 infiltrates into the groove 86 due to the capillary phenomenon. Thus, the ink attached to the nozzle surface 62A is separated away from the nozzle 40.

In addition, the hydrophilicity of wall surfaces and bottom which surround the groove 86 is higher compared to the hydrophilicity of the nozzle surface 62A. Therefore, the ink attached around the nozzle 40 infiltrates effectively into the groove 86 due to the capillary phenomenon, compared to a case where the hydrophilicity of wall surfaces and bottom which surround the groove 86 is the same as the hydrophilicity of the nozzle surface 62A.

In addition, the farther the groove 86 is separated from the nozzle 40, the narrower the width of the groove 86. Thus, the ink that infiltrates in the groove 86 moves to the other end 86B of the groove 86 which is separated away from the nozzle 40 due to the capillary phenomenon compared to a case where the width is uniform.

In addition, the ink that moves to the other end 86B of the groove 86 infiltrates into the groove 90 and is held within the groove 90. Thus, moving of the ink that infiltrates into the groove 86 to the one end 86A of the groove 86 (flowing backward) is suppressed.

In addition, the ink attached to the nozzle surface 62A is separated away from the nozzle 40, and thereby a change of ejection characteristics of the ink droplet (example of a liquid droplet) that is ejected from the nozzle 40 is suppressed. An example of the ejection characteristics is an ejection direction of the ink droplet and it is suppressed that the ink droplet that is ejected from the nozzle 40 comes into contact with the ink attached to the nozzle surface 62A and then the ejection direction is changed.

In addition, in the image forming apparatus 10, the change of the ejection characteristics of the ink droplet that is ejected from the nozzle 40 is suppressed, and thereby quality deterioration of an output image is suppressed.

The invention is described in detail in accordance with a specific exemplary embodiment; however, the invention is not limited to the exemplary embodiment and it is obvious for those skilled in the art that it is possible to take other various embodiments within a range of the invention. For example, the liquid droplet ejection head 36 is a so-called full width array (FWA) type of which the width is greater than the maximum width of the sheet member P; however, the liquid droplet ejection head may be a scanning type in which the head moves in the sheet width direction.

In addition, in the exemplary embodiment described above, as the groove is separated from the nozzle 40, the width of the groove 86 is narrower; however, the width may be the same, or as the groove is separated from the nozzle, the width of the groove may be wider.

In addition, in the exemplary embodiment described above, the edge of the groove 86 is formed to have a U-shaped cross section, but may be formed to have a V-shaped cross section.

In addition, in the exemplary embodiment described above, the depth of the groove 86 is 300 [μm] as an example; however the depth may be changed from the one end 86A of the groove 86 to the other end 86B.

In addition, in the exemplary embodiment described above, the annular groove 90 is formed to surround the entire groove 86; however, the annular groove 90 may not be formed. In this case, the other end 86B of the groove 86 extends to the edge of the nozzle plate 62, and thereby an end surface of the nozzle plate 62 is opened and the ink that infiltrates into the groove 86 is output from the edge portion of the nozzle plate 62.

In addition, in the exemplary embodiment described above, the ink that infiltrates into the groove 86 and moves to the other end 86B of the groove 86 infiltrates into the groove 90 and thereby is held in the groove 90; however, a porous member may be provided instead of the groove 90. In this case, the porous member absorbs and holds the ink.

In addition, in the exemplary embodiment described above, the characteristics of the ink attached to the nozzle surface 62A are not particularly described. For example, the ink having a low static surface tension is likely to spread on the nozzle surface 62A compared to the ink having a high surface tension. Therefore, when the ink having the low static surface tension is used, the ink attached around the nozzle 40 easily infiltrates into the groove 86. For example, in a case where ink having the static surface tension of 30 mN/m or less is used to obtain resolution of the output image that is a top priority, such ink easily infiltrates into the groove 86. The static surface tension is a value measured by using a Wilhelmy surface tensiometer CBVP-Z (Kyowa Interface Science Co., Ltd) in an environment of 23° C. and 55% RH.

In addition, in the exemplary embodiment described above, although there is no specific description, the controller 80 may control a drive source (not illustrated) and apply vibration to the liquid droplet ejection head 36 between jobs in which an image forming operation is not performed. The liquid droplet ejection head 36 vibrates and thereby the ink attached to the nozzle surface 62A moves and infiltrates into the groove 86. Thus, the ink attached to the nozzle surface 62A is separated away from the periphery of the nozzle 40.

In addition, in the exemplary embodiment described above, although there is no specific description, the plural liquid droplet ejection heads 36 for the same color are provided, displaced from each other in the head longitudinal direction, and aligned in the belt circling direction. Accordingly, resolution of an output image is improved.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A liquid droplet ejection head provided with:
an ejection hole that is opened on an ejection surface and ejects a liquid droplet; and
a groove that extends with one end separated from the ejection hole to the other end further separated from the ejection hole than the one end on the ejection surface.

2. The liquid droplet ejection head according to claim 1,
wherein as the groove is separated from the ejection hole, a width of the groove is narrower.

3. The liquid droplet ejection head according to claim 1, further comprising:
a holding section that is connected to the other end of the groove and holds a liquid.

4. The liquid droplet ejection head according to claim 2, further comprising:
a holding section that is connected to the other end of the groove and holds a liquid.

5. An image forming apparatus comprising:
a transporting member that transports a recording medium; and
the liquid droplet ejection head according to claim 1 that ejects a liquid droplet through an ejection hole to the recording medium transported by the transporting member to form an image on the recording medium.

6. An image forming apparatus comprising:
a transporting member that transports a recording medium; and
the liquid droplet ejection head according to claim 2 that ejects a liquid droplet through an ejection hole to the recording medium transported by the transporting member to form an image on the recording medium.

7. The liquid droplet ejection head according to claim 1,
wherein as the groove is separated from the ejection hole, a width of the groove is wider.
